(19) United States
(12) Patent Application Publication
(10) Pub. No.: US 2009/0165658 A1
(43) Pub. Date: Jul. 2, 2009

(54) PRESS DEVICE FOR FOOD

(75) Inventor: Benjamin Schramm, Eppenrod (DE)

Correspondence Address: DARBY & DARBY P.C., P.O. BOX 770, Church Street Station, New York, NY, 10008-0770, US

(73) Assignee: Leifheit AG, Nassau/Lahn (DE)

(21) Appl. No.: 12/338,188

(22) Filed: Dec. 18, 2008

(30) Foreign Application Priority Data
Dec. 28, 2007 (DE) 10 2007 063 097.4

(51) Int. Cl. A47J 19/00

(52) U.S. Cl. 99/510

(57) ABSTRACT

A press device for food includes a pressing plate having a plurality of openings and at least one handle connected to the pressing plate. The openings are configured to each receive a portion of the food product therethrough upon an application of a force to the at least one handle.

### CROSS REFERENCE TO PRIOR APPLICATIONS

Priority is claimed to German Patent Application No. DE 10 2007 063 097.4, filed Dec. 28, 2007.

### FIELD

The invention relates to a press for food products, especially for garlic.

### BACKGROUND

Presses for food products normally comprise a part that encompasses a pressing chamber having, on one side, an opening into which the pressing plunger is inserted and, on the other side, outlet openings for the product to be pressed. Particularly with garlic presses, it is often the case that the part encompassing the pressing chamber is arranged on one of two handles that are hinged together, whereas the pressing plunger is attached, usually movably, to the other handle. When the handles are pivoted towards each other, the pressing plunger is driven into the pressing chamber and the product to be pressed is mashed and pressed through the outlet openings. Such a mincing device, especially for garlic, shallots and the like, is described in Swiss patent specification CH 263006.

These presses known from the state of the art have the drawback, among other things, that they are laborious to clean because of the many parts, some of which are hinged together. In particular, there are many nooks and crannies where residues of the pressed product can get stuck. Moreover, the presses known from the state of the art entail the disadvantage that the pressing force has to be generated exclusively with the fingers by closing one hand, which restricts the range of application for these presses. Another disadvantage is the fact that the size of the pieces of product to be pressed is limited by the size of the pressing chamber provided.

### SUMMARY

In an embodiment, the present invention provides a press device for a food product including a pressing plate having a plurality of openings and at least one handle connected to the pressing plate. The openings are configured to each receive a portion of the food product therethrough upon an application of a force to the at least one handle.

### BRIEF DESCRIPTION OF THE DRAWINGS

The subject matter of the invention is schematically depicted and described in the drawing with reference to the figures, whereby elements having the same function are designated by the same reference numerals. Other features and advantages of various embodiments of the press device for food according to the present invention will become apparent by reading the following detailed description with reference to the attached drawings which illustrate the following:

FIG. 1 is a press device according to an embodiment of the invention, having a bar-like handle;

FIG. 2 is the press device of FIG. 1 shown with a base; and

FIG. 3 is a press device according to another embodiment of the present invention including a handle shaped like a door handle.

### DETAILED DESCRIPTION

It is an aspect of the present invention to provide a press for food products, such as garlic, which can be used easily and configured so as to be sturdy and uncomplicated.

In an embodiment, the present invention provides a press for food products that includes a pressing plate having at least one handle.

The press according to an embodiment of the present invention has the advantage that it can be used virtually irrespective of the size of the product to be pressed. Moreover, it entails the advantage that users can press the pressing plate onto a work surface or special base using their body weight and optionally may use both arms. In particular, users can advantageously twist the pressing plate, so that the resulting shearing action of the holes makes it very easy to mince the product to be minced without having to exert a great deal of force. For example, when the device is used as a garlic press, twisting the pressing plate—while concurrently exerting pressure—causes the peel of a garlic clove to be loosened and separated from the flesh. Once the pressing procedure has been completed, the peel is still to be found under the pressing plate while the flesh will have been squeezed through the holes of the pressing plate.

The open design makes it simple and easy to clean the press. The pressed product and the residues from the pressing procedure can be easily removed by scraping them off the press or the base.

In accordance with an embodiment of the present invention, the product to be pressed is pressed out with a rolling motion and the pressing plate is convex. In another embodiment, it can be provided that the pressing plate is convex in two dimensions and accordingly, has the shape of a spherical segment. In yet another embodiment, the pressing plate is provided flat.

In an embodiment of the press according to the present invention that allows it to be used in a particularly flexible manner, it is provided that the pressing plate is arranged on the handle so as to be replaceable. Thanks to this embodiment, the handle can be used for different pressing plates having, for example, holes with different sizes and/or holes with different spacing.

For purposes of using the press with both hands, it may be provided that the handle has two gripping areas, one for each hand.

In an embodiment of the present invention that is particularly sturdy, the handle can be configured, for example, like a bar. In another embodiment, the handle is shaped like a door handle, which makes it very easy to access the top part of the pressing plate, thus greatly facilitating its cleaning. In yet another embodiment, a scraper is provided to remove adhering pressed products and/or product residues. For example, the scraper can be arranged on the handle in such a way that it can be removed.

In an embodiment of the press according to the present invention that functions efficiently, a base is provided on which the product to be pressed can be positioned in preparation for the pressing procedure. In particular, the base can be provided with projections. These projections can be configured in such a way that they prevent the product to be pressed from sliding away. It can also be provided that the projections can be inserted, at least partially, into the openings of the pressing plate. Preferably, the distance between the projections corresponds to the distance between the openings. Similarly, it is preferably provided in this embodiment that the outer diameter of the projections is equal to or smaller than the inner diameter of the openings.

In another embodiment of the present invention, the press, preferably the pressing plate, has a peeler. This allows the product to be pressed, for example, a garlic clove, to be peeled prior to the pressing procedure without the need for an additional utensil.

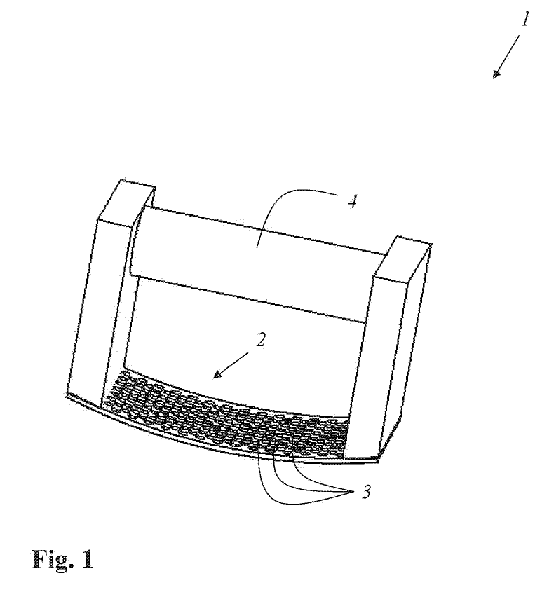

FIG. 1 shows a press 1 according to an embodiment of the present invention, with a pressing plate 2 having a plurality of openings 3 through which the product to be pressed can be squeezed. The pressing plate 2 is arranged on a bar-like handle 4. Preferably, in order to be able to exert a shearing force in addition to the pressing force by twisting the pressing plate 2, the pressing plate 2 is configured with a convex shape as seen from the perspective of the product to be pressed.

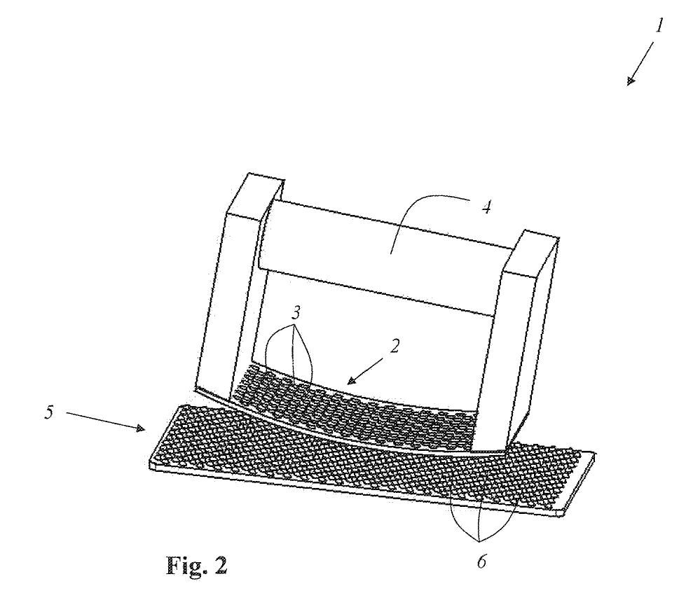

FIG. 2 shows the press according to an embodiment of the present invention together with a base 5 on which the product to be pressed can be easily positioned in preparation for the pressing procedure. The base 5 is preferably provided with projections 6, whereby the spacing of the projections and the size of the projections are selected in such a way that the projections 6 can be inserted into the openings 3 of the pressing plate 2.

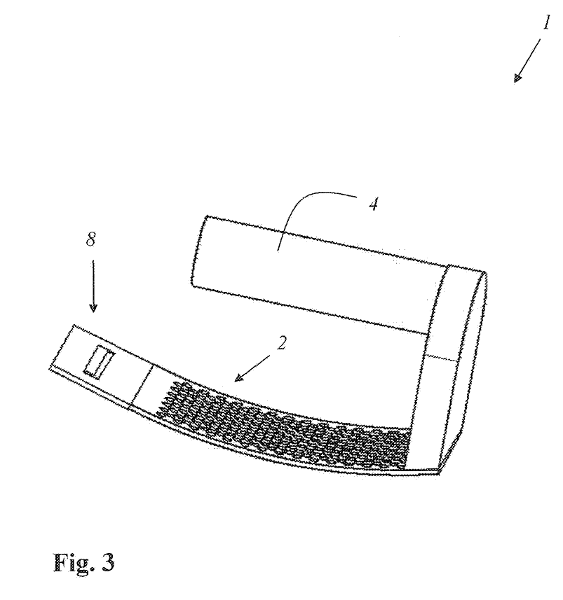

FIG. 3 shows another embodiment of the press according to the present invention, having a handle 7 shaped like a door handle that makes the pressing plate 2 easily accessible from the top. In the illustrated embodiment, the press 1 has a peeler 8 arranged on the pressing plate 2, the peeler 8 making it possible, for example, to peel garlic cloves prior to the pressing procedure.

While the invention was described with reference to specific embodiments, it is understood by those having ordinary skill in the art that changes and modifications can be implemented without deviating from the protective scope of the claims presented below.

1-15. (canceled)

16: A press device for a food product comprising:
a pressing plate including a plurality of openings; and
at least one handle connected to the pressing plate,
wherein the openings are configured to each receive a portion of the food product therethrough upon an application of a force to the at least one handle.

17: The press device according to claim 16, wherein the pressing plate is convex.

18: The press device according to claim 16, wherein the pressing plate includes a spherical segment.

19: The press device according to claim 16, wherein the pressing plate is flat.

20: The press device according to claim 16, wherein the pressing plate is removably connected to the handle.

21: The press device according to claim 16, wherein the handle includes two gripping areas configured to be gripped simultaneously by a user's hands.

22: The press device according to claim 16, wherein the handle has a shape of a bar.

23: The press device according to claim 16, wherein the handle has a shape of a door handle.

24: The press device according to claim 16, further comprising a scraper adapted to remove portions of the food product adhering to the pressing plate.

25: The press device according to claim 16, further comprising a base adapted to receive the food product prior to the application of the force.

26: The press device according to claim 25, wherein the base includes a plurality of projections.

27: The press device according to claim 25, wherein the base includes a plurality of projections on an upper surface thereof; the projections being configured to at least partially extend into the openings of the pressing plate.

28: The press device according to claim 25, wherein the base includes a plurality of projections on an upper surface thereof, the projections being disposed with a spacing corresponding to a spacing of the openings of the pressing plate.

29: The press device according to claim 26, wherein the projections have a cross-sectional area that is smaller than or equal to a cross-sectional area of the openings.

30: The press device according to claim 25, further comprising a peeler.

31: The press device according to claim 30, wherein the peeler is integral to the pressing plate.

32: The press device according to claim 26, wherein the projections have an outer diameter that is smaller than or equal to an inner diameter of the openings.

33: The press device according to claim 28, wherein the projections have an outer diameter that is smaller than or equal to an inner diameter of the openings.

34: The press device according to claim 16, wherein the food product is garlic.

35: The press device according to claim 16, wherein the openings are configured to each receive a respective portion of the food product therethrough so as to mince the food product.
